(19) United States
(12) Patent Application Publication
(10) Pub. No.: US 2007/0295522 A1
(43) Pub. Date: Dec. 27, 2007

(54) HAND POWER TOOL

(76) Inventors: Ulrich Bohne, Kohlberg (DE); Justus Lamprecht, Dusslingen (DE); Juergen Wiker, Hangzhou/Bing Jiang District (CN); Dietmar Saur, Gomaringen (DE); Axel Kuhnle, Freiberg A.N., (DE); Steffen Tiede, Herrenberg (DE); Joerg Lemmel, Weinstadt (DE); Joachim Schadow, Dettenhausen (DE); Thomas Schomisch, Filderstadt (DE); Joerg Maute, Sindelfingen (DE)

Correspondence Address: STRIKER, STRIKER & STENBY, 103 EAST NECK ROAD, HUNTINGTON, NY, 11743, US

(21) Appl. No.: 11/752,540

(22) Filed: May 23, 2007

(30) Foreign Application Priority Data
Jun. 21, 2006 (DE) 10 2006 027 774.0

(51) Int. Cl. B25D 17/00

(52) U.S. Cl. 173/162.2

(57) ABSTRACT

In a hand power tool having a housing which at least in part comprises an inner housing and an outer housing, and in which the inner housing and the outer housing are spaced apart from one another, at least one damping element is provided between the inner housing and the outer housing, so that the inner housing and the outer housing are decoupled from one another.

### CROSS-REFERENCE TO A RELATED APPLICATION

The invention described and claimed hereinbelow is also described in German Patent Application DE 102006027774.0 filed on Jun. 21, 2006. This German Patent Application, whose subject matter is incorporated here by reference, provides the basis for a claim of priority of invention under 35 U.S.C. 119(a)-(d).

### BACKGROUND OF THE INVENTION

The invention is based on a hand power tool.

In work with electrical tools, such as right-angle sanders, drills, and drill hammers, more or less severe vibration occurs, which is engendered, among other factors, by the imbalance of the masses, rotating at high speed, of the motor, gear, tool inserts, and so forth, and by the machining of workpieces. The vibration is transmitted to the user of the electrical tool via the handle and causes fatigue in the user's hand. Relatively long-term work with severely vibrating electrical tools can even impair health.

From German Patent Disclosure DE 40 00 861 A, a handheld electric power tool is known in which the motor housing is surrounded by a shell housing, which is decoupled vibrationally from the motor housing and is provided with a handle.

### SUMMARY OF THE INVENTION

In keeping with these objects and with others which will become apparent hereinafter, one feature of the present invention resides, briefly stated, in a hand power tool, comprising a housing which at least in part includes an inner housing part and an outer housing part, said inner housing part and said outer housing part being spaced from one another; and at least one damping element provided between said inner housing part and said outer housing part, so that said inner housing part and said outer housing part are decoupled from one another.

The housing of the hand power tool of the invention at least partially comprises a load-bearing inner housing and an outer housing that surrounds the inner housing. The hand power tool of the invention accordingly has a double-walled housing at least in part. The inner housing and the outer housing are spaced apart from one another, so that between them an interstice in the form of a gap is formed. The spacing between the inner housing and the outer housing may be essentially equal, distributed over the housing, so that the inner housing and the outer housing are essentially parallel to one another. However, the spacing may also be different, distributed over the housing, so that in some regions of the housing the interstice between the inner housing and the outer housing is greater than in other regions.

The damping of vibration that is generated in operation of the hand power tool is achieved by providing that the inner housing and the outer housing are decoupled from one another by at least one damping element in the interstice between the inner housing and the outer housing. All the connections between the inner housing and the outer housing are embodied in vibration-damping fashion. The improved vibration properties of the hand power tool of the invention enhance the user-friendliness of the hand power tool.

The inner housing serves to receive components of the hand power tool, such as an electric motor or electronic components. The outer housing, conversely, surrounds only the inner housing and establishes the connection with the user of the hand power tool. The inner housing and the outer housing may each be in one piece, for instance in the form of a cup, so that the components can be introduced into the inner housing from the open side. The half-shells may be connected to one another in various ways, for instance by a screw connection, detent connection, etc. A combination of the housing forms described is also possible, for instance in such a way that the inner housing is constructed in two parts of two half-shells, and the outer housing is constructed in one piece from a cup-shaped housing.

The inner housing and the outer housing are preferably of plastic, and either the same or different plastics may be used for the inner housing and the outer housing. Alternatively, the inner housing and/or the outer housing may be of metal, for instance.

The damping properties of the damping element may be varied by means of the material, shape, thickness, and other parameters of the damping element.

In a first embodiment, the damping element may be of an elastic material. Elastomers or foams, for instance, can be considered as the elastic materials. On the one hand, the entire interstice between the inner housing and the outer housing may be equipped with a damping element, for instance in such a way that the interstice is filled with a foam. On the other, however, a plurality of damping elements may also be provided in the interstice, distributed regularly or irregularly over the housing. By the positioning of the damping elements in defined regions of the housing, the vibration properties of the hand power tool can be varied in a favorable way, or in other words reduced in a targeted way. If multiple damping elements distributed over the housing are provided, then different elastic materials may also be selected for the damping elements, in order to reduce vibration in defined regions of the housing in a targeted way.

A damping element of an elastic material may have various shapes. For instance, it may be annular, so that it is located in a transverse axis of the hand power tool, extending all the way around over the circumference between the inner housing and the outer housing. It may also be striplike, for instance, and may be located in the interstice, in the longitudinal direction of the hand power tool. A damping element of an elastic material may also be embodied in profiled form, to increase the vibration absorption. Thus the damping element may have channels, for instance, or maybe or be folded multiple times in either the longitudinal or the transverse direction of the hand power tool, resulting for instance in a rectangular, zigzag-shaped or other cross section of the damping element.

In a second embodiment, the damping element may also be a spring element. The spring element may for instance be a helical spring, spiral spring, leaf spring, or cup spring. The spring element may for instance be of metal or plastic. In the embodiment of a spring element, the damping element may also be adapted in its damping properties by the choice of material, number, location, spring rate, and other parameters. For instance, a plurality of spring elements may be located between the inner housing and the outer housing, and they may be distributed uniformly or arbitrarily over the circumference of the hand power tool. The spring elements may then have either the same or different spring rates.

Instead of a separate damping element that is located between the inner housing and the outer housing, the damping element may also be embodied integrally with the inner housing or with the outer housing. In particular, the damping element then forms a spring element which may be integrally molded onto the inner housing or the outer housing, for instance in the form of a tonguelike protrusion. Spring elements of that kind have a supporting function, on the one hand, and stop and compression functions on the other. If a spring element of this kind is formed integrally onto the inner housing in one piece, for instance, then its free end rests on the inner face, in other words, the face toward the inner housing, of the outer housing. Conversely, such a spring element may be formed integrally in one piece onto the outer housing, and its free end may rest on the outer face, that is, the face toward the outer housing, of the inner housing. Another damping element embodied in one piece with the inner housing or with the outer housing is a detent element, which establishes a detent connection of the inner housing and the outer housing. A detent element may likewise have elastic properties that are capable of accomplishing vibration damping.

Effective decoupling of the inner housing and the outer housing can furthermore be attained by providing that the two housing parts are joined to one another via struts. Since via struts, only comparatively little vibration transmission takes place, they also represent a simple yet effective form of vibration damping. Advantageously, the struts are formed integrally in one piece onto the inner housing and the outer housing. However, they may also be embodied in one piece with either only the inner housing or only the outer housing and joined to the respective other housing part in some other way.

A damping element may furthermore be provided in the form of a damping cushion filled with a fluid, that is, a gas, such as air, or with a liquid, such as water, oil, or gel. The damping cushion may for instance be an annular damping cushion, which is located in a transverse axis of the hand power tool, extending all the way around between the inner housing and the outer housing. Instead of one or more annular damping cushions extending all the way around, one or more striplike damping cushions may be provided in the longitudinal direction of the hand power tool. The damping cushion has a sheath, preferably of an elastic material, that is impermeable to the fluid. The sheath of the damping cushion may be subdivided a single time or multiple times to enhance the damping properties, so that the sheath has a honeycomblike structure, for instance.

A honeycomblike structure of the damping cushion furthermore has the advantage that even if individual honeycomb elements are damaged, the damping action of the entire damping cushion is still not lost. A further advantage of a fluid-, in particular gas-, filled damping cushion is the adjustability of the damping properties of the damping cushion. With the aid of a comparatively simple construction, the damping cushion can be embodied in such a way that the pressure in the damping cushion, and thus the damping action, is adjustable. For that purpose, the damping cushion may for instance be equipped with a valve, by way of which the pressure in the damping cushion can be adapted, for instance to the particularly application.

In a further embodiment, the damping element comprises a net, woven fabric, mesh, knitted fabric, or the like, of metal, plastic or natural material, or a combination of these materials. A damping element of this kind can, as described above for a damping element of an elastic material, be located in various ways between the inner housing and the outer housing.

Depending on the embodiment, the damping element may be joined to the inner housing and outer housing in various ways. For instance, it can be integrally molded onto the housing parts by injection molding during the molding of the two housing parts. This is done by placing the damping element, such as one or more spring elements, in the cavity in the injection mold and sheathing the housing parts during the molding in such a way that the damping element is solidly joined to the two housing parts. A prefabricated damping element comprising an elastic material may also be formed integrally in this way onto the housing parts by injection molding. Alternatively, the damping element comprising a thermoplastic elastomer may be integrally molded directly to the inner and outer housings in a dual-component injection molding process. The damping element may also be joined to the housing parts in some other way, such as in material-locking fashion by means of adhesive bonding or welding.

For attaching the damping element, detent elements may also be provided on the housing parts and/or on the damping element. The connection between the damping element and the inner housing on the one hand and the outer housing on the other may additionally be attained by means of a form lock. For instance, the inner housing may have indentations, such as beads, grooves, or the like, or raised areas, such as protrusions, ribs, or the like, in which the damping element is received in form-locking fashion. On the other hand, particularly on its inner face toward the inner housing, the outer housing may have protrusions, ribs, or raised areas of some other kind, which form a form lock with the damping element.

In a preferred embodiment of the hand power tool of the invention, at least one adjusting element is provided, with which the prestressing of the damping element is adjustable. This allows the damping properties to be adapted, for instance to the particular to the application or to the user of the hand power tool. By way of the adjusting element, the outer housing, for instance, may be pressed more strongly or less strongly against the inner housing, so that the damping element is under greater or lesser tension. The adjusting element itself is optionally embodied in decoupled form. In a simple embodiment, the adjusting element is a screw.

According to the invention, the housing at least partially comprises a double-walled housing that comprises the inner housing and the outer housing. This means that in one embodiment of the hand power tool of the invention, the entire housing is constructed from an inner housing and an outer housing.

In another embodiment, conversely, one or more parts of the housing comprise an inner housing and an outer housing. In some hand power tools, such as right-angle sanders, the housing is constructed of at least two housing parts, which are located after the other in a longitudinal axis of the hand power tool and joined together: a rear housing part, which is the motor housing, for instance of plastic, and a front housing part, which is the gearbox, for instance of metal. The motor housing receives an electric motor, among other elements, which via the gear accommodated in the gearbox drives a driven spindle and a sanding wheel connected to the driven spindle in a manner fixed against relative rotation. The terms “front” and “rear” refer to the direction in which the hand power tool works. A handle is integrally molded onto the rear housing part, that is, the motor housing. The housing part that forms the handle may either be formed integrally in one piece onto the motor housing, or it may form a separate housing part that is joined to the motor housing. In a hand power tool of this kind, only the motor housing, or the motor housing with the handle integrally formed onto it, may for instance be embodied in double-walled fashion with an inner housing and an outer housing.

In a further embodiment, only the part of the housing that forms a handle is constructed of an inner housing and an outer housing. The user of the hand power tool then comes into contact with only the outer housing, but not with the inner housing.

In a special embodiment, the handle has a double-walled housing comprising an inner housing and an outer housing, with a damping element between them, in only one portion. In particular, this portion is the region of the handle that forms a resting face for the user's hand.

The inner housing and the outer housing may be joined by means of a screw connection, in addition to being joined by the damping element. The screw connection is likewise embodied in vibration-damped fashion, so that the decoupling of the inner housing and the outer housing is assured. For that purpose, the screws may be surrounded by rings or sleeves of elastic material, for instance. These screw connections may also serve the purpose of adjustability of the damping function of the damping element, in that the screws can be tightened variously tightly, and thus the initial tension of the damping element can be varied.

Since the damping element makes the connection between the two housing parts, if the damping element should fail, for instance from damage or breakage, there is the risk that the connection between the inner housing and the outer housing will no longer be sufficiently stable. It is therefore advantageous, in addition to the damping element, in the interstice between the inner housing and the outer housing, to provide a form lock that creates an additional connection. The form lock should also be embodied in vibration-decoupled or vibration-damped fashion, for instance by providing that an elastic material is located between the inner housing and the outer housing in the region of the form lock.

The described embodiments of the damping element may be employed not only individually but also in combined form.

The hand power tool of the invention may for instance be an electrically drivable right-angle sander, screwdriver, drill, or drill hammer.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a schematic side view of a handheld electrical right-angle power sander;

FIG. 2 is a detail in perspective of the right-angle power sander of FIG. 1, with one embodiment of a damping element;

FIG. 2a shows a detail of the right-angle power sander of FIG. 2;

FIG. 3 is a detail in perspective of the right-angle power sander of FIG. 1, with a further embodiment of a damping element;

FIG. 4 is a detail in perspective of the right-angle power sander of FIG. 1, with a further embodiment of a damping element;

FIG. 5 is a detail of a further embodiment of the right-angle power sander of FIG. 1;

FIG. 6 is a detail in perspective of the right-angle power sander of FIG. 1, with a further embodiment of a damping element and of an adjusting element;

FIG. 7 is a detail in perspective of the right-angle power sander of FIG. 1, with an inner housing and an outer housing in the region of the handle;

FIG. 8 is a detail in perspective of the right-angle power sander of FIG. 1, with an inner housing and an outer housing in the portion of the handle;

FIG. 9 is a detail in perspective of the right-angle power sander of FIG. 1, with an inner housing and an outer housing in the portion of the handle;

FIG. 10a is a detail in perspective of the right-angle power sander of FIG. 1, with an inner housing and an outer housing in the portion of the handle;

FIG. 10b is a detail of the right-angle power sander of FIG. 10a with the inner housing and the outer housing, in the installed state;

FIG. 11 is a detail of the right-angle power sander of FIG. 1 with the inner housing and the outer housing, in a portion of the handle;

FIG. 12 is a detail of the right-angle power sander of FIG. 11, showing the outer housing in perspective.

### DESCRIPTION OF THE PREFERRED EMBODIMENTS

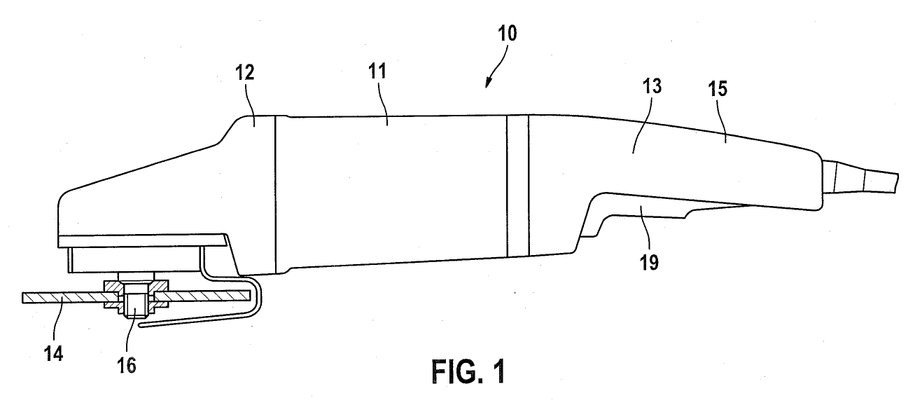

The right-angle power sander 10 shown schematically in FIG. 1 represents one embodiment of the hand power tool of the invention. In the embodiment shown, the right-angle power sander 10 includes three housing parts: a first housing part 11 for receiving an electric motor (not shown), among other elements; a second housing part 12 for receiving a gear (not shown), among other elements; and a third housing part 13, which is embodied as a handle 15. A drive shaft that can be driven by an electric motor is coupled to a driven shaft 16, via a gear that comprises a driving gear wheel and a driven gear wheel. A sanding wheel 14 is located on the driven shaft 16 in a manner fixed against relative rotation. The electric motor is switched on and off by the user via an ON/OFF switch 19.

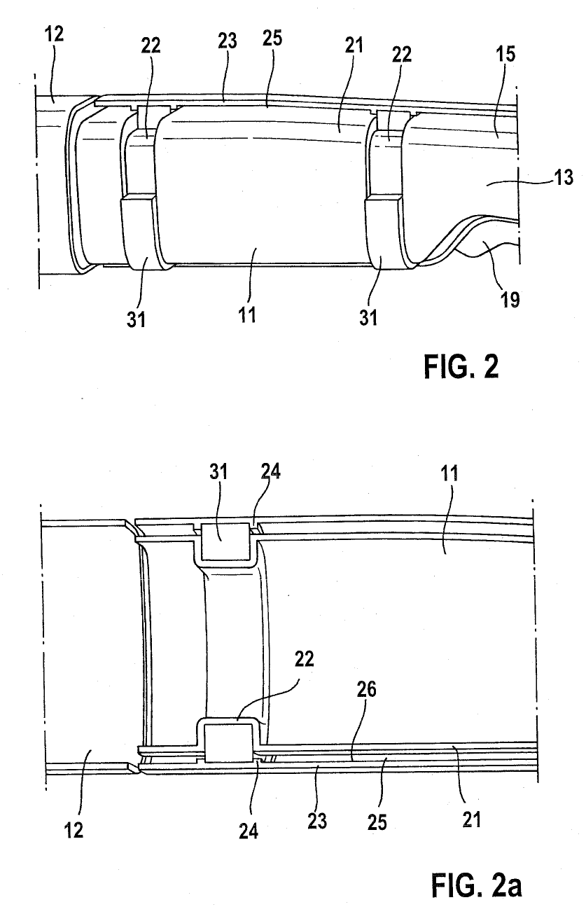

FIG. 2 shows a schematic detail of the right-angle power sander 10 of FIG. 1. The first housing part 11 is embodied in one piece with the third housing part 13 that is embodied as a handle 15. The housing parts 11 and 13 are double-walled, with an inner housing 21 and an outer housing 23. The inner housing 21 and the outer housing 23 are spaced apart from one another, so that between them an interstice 25 in the form of a gap is formed. Between the inner housing 21 and the outer housing 23, at least one damping element 31 for vibration decoupling is provided according to the invention. In the embodiment shown in FIG. 2, two annular damping elements 31 of elastic material extend all the way around the circumference of the right-angle power sander 10. For greater clarity in FIG. 2, some parts of the annular damping elements 31 have been cut away. Two encompassing grooves 22 are made in the inner housing 21, for receiving the damping elements 31. The sectional view in FIG. 2a further shows that the outer housing 23, on its inner face 26, to both sides of the damping element 31, has encompassing ribs 24, which likewise receive the damping element 31. The groove 22 and the ribs 24 thus allow the damping element 31 to be received in form-locking fashion.

The damping elements 31 shown in FIG. 2, comprising an elastic material, may alternatively be embodied as damping cushions that are filled with a fluid.

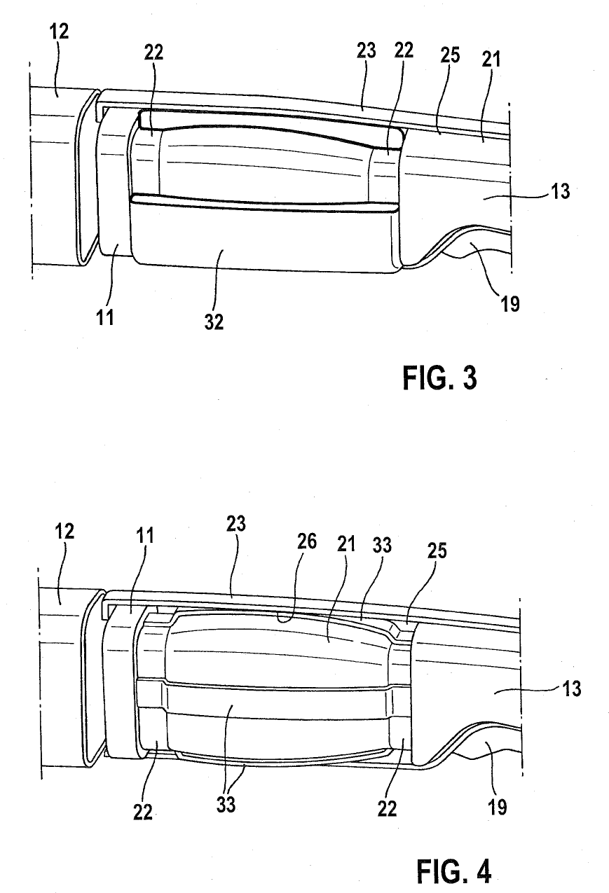

FIG. 3 shows an alternative embodiment as well as an alternative location of a damping element. The damping element is a damping cushion 32 that is filled with a fluid, that is, a gas, or a liquid. The schematic illustration in FIG. 3 shows a damping cushion 32 which extends all the way around the circumference and which in the region of the first housing part 11 fills up substantial portions of the interstice 25 between the inner housing 21 and the outer housing 23 in the longitudinal direction of the right-angle power sander 10. For greater clarity, some of the damping cushion 32 is cut away in FIG. 3 as well. It can also be seen from FIG. 3 that for form-locking receiving of the damping cushion 32, grooves 22 are again made into the inner housing 21. It can furthermore be seen in FIG. 3 that at least in the region of the housing part 11 where the damping cushion 32 is provided, the interstice 25 is not the same size throughout. In the longitudinal direction between the grooves 22, the inner housing 21 is curved, and as a result the interstice 25 near the grooves 22 is larger than in the middle between the two grooves 22. The damping cushion 32 compensates for the variously sized interstice 25. In this way, an amplified vibration damping can be attained purposefully in some regions. A fluid-filled damping cushion 32 is especially well suited for this, since the fluid in the damping cushion 32 distributes itself over the existing space accordingly.

The damping cushion 32 shown in FIG. 3 may alternatively be embodied as a damping element of an elastic material.

In FIG. 4, a further embodiment of a damping element is shown. In the region of the first housing part 11, a plurality of spring elements 33, in the form of leaf springs, are located in the longitudinal direction of the right-angle power sander 10 in the interstice 25 between the inner housing 21 and the outer housing 23. On their ends, the spring elements 33 are received in encompassing grooves 22 of the inner housing 21 and are joined to the inner housing 21. Approximately halfway along the length of the spring elements 33, the spring elements 33 rest on the inner face 26 of the outer housing 23.

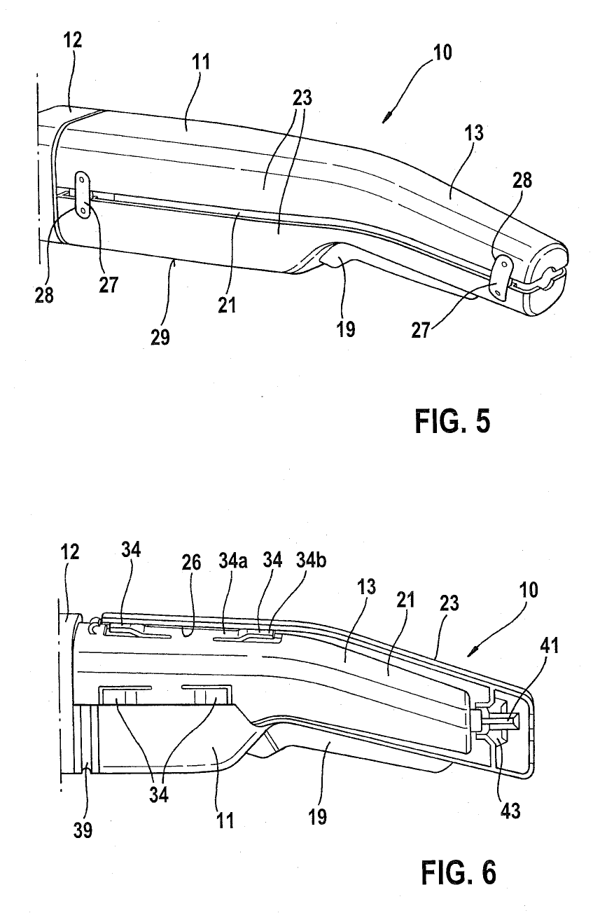

In the embodiment of the right-angle power sander 10 shown in FIG. 5, the outer housing 23 comprises two half-shells, which are placed on one another in the longitudinal direction of the right-angle power sander 10 and are joined with the aid of retaining elements 27, shown here in the form of retaining tabs. The retaining elements 27 connect the half-shells of the outer housing 23 without contacting the inner housing 21. The decoupling of the inner housing 21 and the outer housing 23 is thus assured with the retaining elements 27 as well. The retaining elements 27 may be separate components, as shown in FIG. 5, or may be embodied in one piece with one of the half-shells. In the region of the retaining elements 27, the half-shells of the outer housing 23 have corresponding recesses 28 for receiving the retaining elements 27, so that the retaining elements 27 are flush with the outer face 29 of the outer housing 23, rather than sitting on top of the outer housing 23. The retaining elements 27 may be joined to the half-shells of the outer housing 23 via screws or via detent elements, for instance. Moreover, the retaining elements 27 may be embodied in such a way that the initial tension of the damping element (not shown here) located between the inner housing 21 and the outer housing 23 is variable.

Unlike what is provided in the embodiment shown in FIG. 5, the half-shells of the outer housing may also be joined to one another and connected to one another (not shown) in a transverse axis of the right-angle power sander 10 as well.

FIG. 6 first shows a further embodiment of a damping element, in the form of spring elements 34 which are embodied in one piece with the inner housing 21. The spring elements 34 take the form of leaf springs, whose first end 34a is integrally formed onto the inner housing 21 and whose second, free end 34b rests on the inner face 26 of the outer housing 23. The spring elements 34 are provided in the region of the first housing part 11. Alternatively or in addition, such spring elements may also be provided (not shown) in the region of the third housing part 13 embodied as a handle 15.

FIG. 6 also shows an adjusting element 41, with which the initial tension of the damping elements, in this case the spring elements 34, can be adjusted. With the aid of the adjusting element 41, via the pressure plate 43 that is connected to the outer housing 23, a contact pressure can be exerted on the outer housing 23, as a result of which the outer housing 23 is pressed against the spring elements 34. The adjusting element 41 may for instance be a screw, which can be adjusted by the user of the right-angle power sander 10.

Between the first housing part 11 and the second housing part 12, a further damping element 39 is also provided, in the form of an encompassing damping ring of an elastic material.

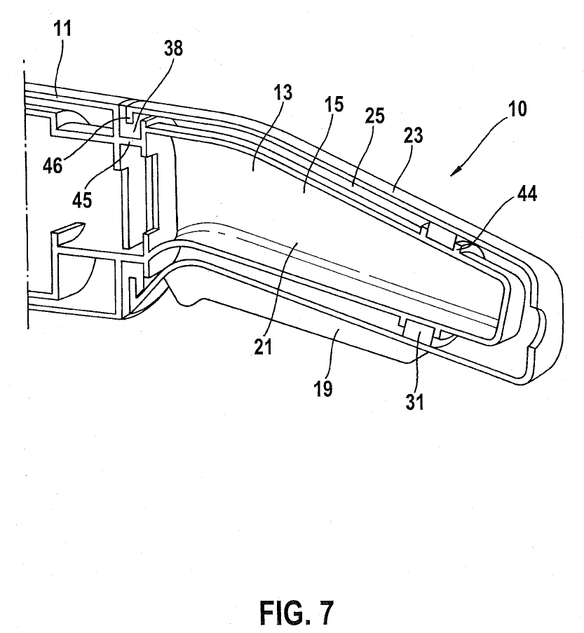

In the embodiment of the right-angle power sander 10 shown in FIG. 7, the double-walled housing comprising the inner housing 21 and the outer housing 23 is limited to the third housing part 13, that is, to the handle 15. The inner housing 21, in the embodiment shown, is embodied in one piece with the first housing part 11. The damping element 31, here comprising elastic material, provides for the decoupling of the inner housing 21 and the outer housing 23. It is located annularly in the interstice 25 and is received in form-locking fashion between annular ribs 44 on the inner housing 21. Moreover, in the region between the first housing part 11 and the third housing part 13, an annular, encompassing damping element 38 is provided, which is received in an annular groove 45. The outer housing 23 is provided with a collar 46, which is surrounded by the damping element 45 in such a way that no contact is made with the outer housing 23 and the inner housing 21. The form lock between the inner housing 21 and the inner housing 23 serves to secure the connection between the housing parts 21 and 23 in the event of failure of the damping element 44.

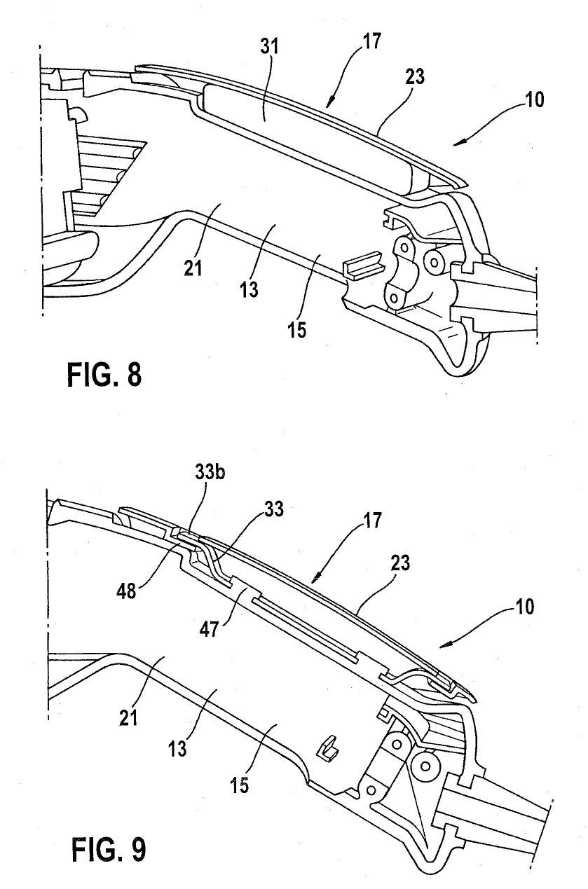

FIGS. 8 and 9 show further embodiments of vibration damping in the region of the third housing part 13, embodied as a handle 15. In this case, only in a portion 17 of the handle 15 is the housing constructed from an inner housing 21 and an outer housing 23. This portion 17 forms the resting face for the hand of the user of the right-angle power sander 10. Only in this portion 17 is the inner housing 21 surrounded by a shell-like outer housing 23 and provided with a damping element located between them. In FIG. 8, a damping element 31 of elastic material is shown, which may alternatively be a fluid-filled damping cushion. In FIG. 9, conversely, a damping element in the form of spring element 33 is shown. The spring element 33 takes the form of a leaf spring. The inner housing 21 is provided with tabs 47, which fix the spring element 33 to the inner housing 21. The outer housing 23 is likewise is provided with tabs 48, which are engaged on the inside by the free ends 33b of the spring element 33. This makes a vibration-damped connection possible between the inner housing 21 and the outer housing 23 via the spring element 33.

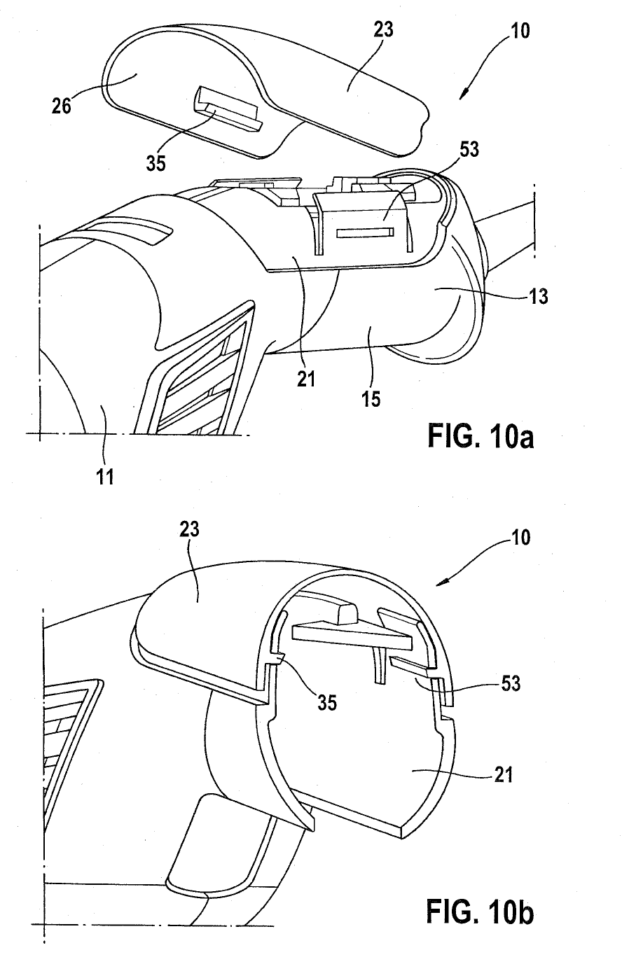

In FIGS. 10a and 10b, the handle 15, as in FIGS. 8 and 9, is likewise equipped with a double-walled housing comprising an inner housing 21 and an outer housing 23 in only a portion 17, which is provided as a resting face for the user's hand. For vibration damping between the inner housing 21 and the outer housing 23, detent elements 35 in the form of resilient tongues with detent hooks are formed integrally in one piece onto the inner face 26 of the outer housing 23. The inner housing 21 is correspondingly equipped with tabs 53, so that the detent hooks of the detent elements 35 engage the tabs 53 from behind. The vibration properties may be varied by means of the choice of material, position, length, cross section, and so forth of the detent elements 35 and of their counterparts, that is, the tabs 53.

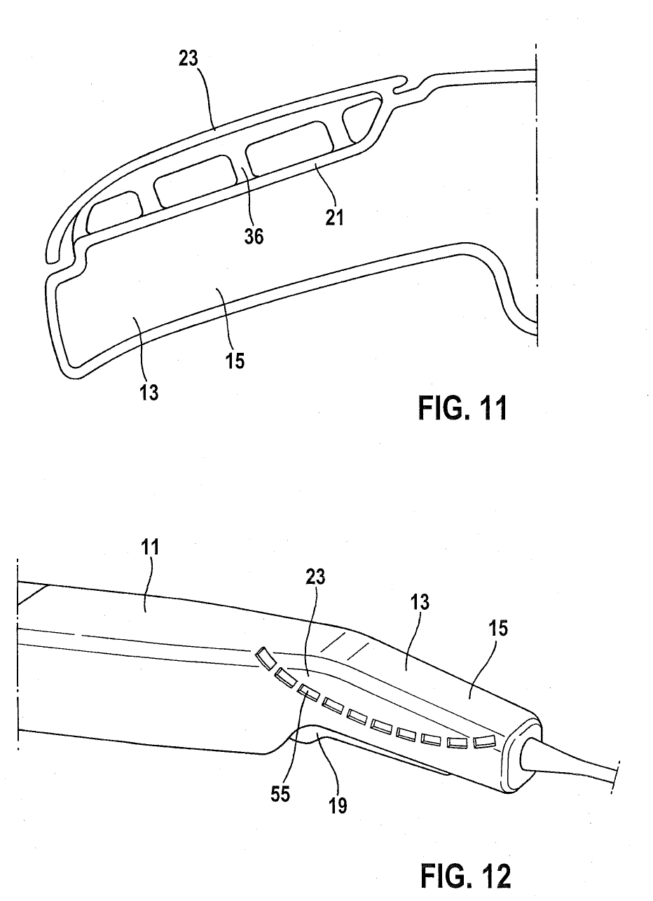

In a further embodiment in FIG. 11, the handle 15, as in FIGS. 8 and 9 as well as 10, is again equipped with a double-walled housing comprising an inner housing 21 and an outer housing 23 in only one portion 17, intended as a resting face for the user's hand. For vibration damping, the inner housing 21 and the outer housing 23 are joined together via struts 36. The struts 36 may be embodied either in one piece with the inner housing 21 or in one piece with the outer housing 23. In a simple embodiment, the struts 36 are integrally formed in one piece onto both the inner housing 21 and the outer housing 23.

FIG. 12, finally, shows how vibration can additionally be reduced by means of recesses 55 in the outer housing 23. The recesses 55 are provided in the region of the third housing part 13 that serves as a handle 15. By means of such recesses 55, the propagation of vibration along the handle 15 can be reduced.

It will be understood that each of the elements described above, or two or more together, may also find a useful application in other types of constructions differing from the type described above.

While the invention has been illustrated and described as embodied in a hand power tool, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A hand power tool, comprising a housing which at least in part includes an inner housing part and an outer housing part, said inner housing part and said outer housing part being spaced from one another; and at least one damping element provided between said inner housing part and said outer housing part, so that said inner housing part and said outer housing part are decoupled from one another.

2. A hand power tool as defined in claim 1, wherein said damping element is configured as an element composed of an elastic material.

3. A hand power tool as defined in claim 1, wherein said damping element is configured as a spring element.

4. A hand power tool as defined in claim 1, wherein said spring element is formed of one piece with one of said housing parts.

5. A hand power tool as defined in claim 4, wherein said spring element is configured as a detent element.

6. A hand power tool as defined in claim 1, wherein said damping element is configured as a damping cushion filled with a fluid.

7. A hand power tool as defined in claim 1, wherein said damping element is composed of struts.

8. A hand power tool as defined in claim 1; and further comprising at least one adjusting element for adjusting a prestressing of said damping element.

9. A hand power tool as defined in claim 1, wherein said housing includes a handle, said at least one damping element being provided at least in a region of said handle, said inner housing part and said outer housing part between said inner housing part and said outer housing part.

10. A hand power tool as defined in claim 1, wherein said at least one damping element is provided in a portion of said handle, said inner housing part and said outer housing part, between said inner housing part and said outer housing part.

11. A hand power tool as defined in claim 10, wherein said at least one damping element is provided in a region of a resting face for a user's hand of said handle.
